(19) United States
(12) Patent Application Publication
(10) Pub. No.: US 2025/0334446 A1
(43) Pub. Date: Oct. 30, 2025

(54) OPTICAL SYSTEMS AND METHODS FOR HIGH SENSITIVITY PUSH BROOM HYPERSPECTRAL IMAGING

(71) Applicant: HI-Spectral, LLC, Kula, HI (US)

(72) Inventor: Haosheng LIN, Kula, HI (US)

(73) Assignee: HI-Spectral, LLC, Kula, HI (US)

(21) Appl. No.: 19/192,554

(22) Filed: Apr. 29, 2025

Related U.S. Application Data
(60) Provisional application No. 63/640,490, filed on Apr. 30, 2024.
(60) Provisional application No. 63/723,931, filed on Nov. 22, 2024.

(51) Int. Cl. G01J 3/02; G01J 3/04; G01J 3/28

(52) U.S. Cl. CPC G01J 3/021; G01J 3/04; G01J 3/2823; G01J 2003/045; G01J 2003/2826

(57) ABSTRACT

An Offner spectrometer for use in a multi-slit hyperspectral imaging system for imaging a remote object includes a first surface that is a transmissive surface having a narrow slit receiving light from a multi-spectral light source, a second curved transmissive surface receiving light from the first surface, a third curved reflective surface receiving light from the second surface, a fourth reflective surface that is a curved surface with a grating receiving light from the third surface and diffracting and reflecting light, a fifth surface that is curved reflective surface receiving light from the fourth surface, a sixth curved transmissive surface receiving light from the fifth surface, and a seventh surface that is a focal plane of the Offner spectrometer receiving light from the sixth surface. Each curved surface has X and Y prescriptions that are decoupled.

### CROSS-REFERENCE TO RELATED APPLICATIONS

The present application claims priority to Provisional Ser. No. 63/723,931 filed on Nov. 22, 2024, and Provisional Ser. No. 63/640,490 filed on Apr. 30, 2024, the contents of each are incorporated in its entirety.

### BACKGROUND

### Field

The present disclosure relates to optical systems and methods for high sensitivity hyperspectral imaging of a 2-dimensional spatial field by multiple measurements of the scene sequentially. This disclosure further relates to optical systems and methods for high sensitivity hyperspectral imaging of a large 2-dimensional spatial field by combining separate measurements of adjacent 2-dimensional spatial fields obtained in rapid succession.

### Description of the Related Art

Conventional long-slit spectrographs measure the spectra from a narrow line and require the use of a scanning mechanism to cover a 2-dimensional scene. Push Broom Hyperspectral Imagers (HSIs) for earth observations are down-looking long-slit spectrographs hosted in satellites. They are very effective instruments for hyperspectral imaging of the earth as the slit oriented perpendicular to the direction of travel automatically sweeps a 2-dimensional area on the ground due to the orbital motion of the satellite.

It is challenging for push broom hyperspectral imagers to achieve high sensitivity due to the high altitude of the satellites, the limitation on telescope aperture in space, and the short exposure time needed to limit the smearing of the scene along the track of satellite motion. Existing HSIs typically employee optical systems with fast optics, customarily quantified by the Focal Ratio, F/#, of the beams entering the final focal plane of the instrument. The F/# of an optical system is defined as the ratio between the focal length of the final focusing beam and the aperture of the telescope, with smaller F/#(“faster” optical system) signifying a higher photon collecting power for a given focal length. Alternatively, the speed of an optical system is also quantified by the Numerical Aperture (NA=0.5/F #). For example, the upcoming Carbon Mapper is equipped with a F/1.8 Dyson spectrometer to provide a 4-time improvement in the collecting power of the HSI over previous generation of instrument a F/3.6 spectrometer (Shaw et al., 2023).

The proliferation of CubeSat technologies has greatly lowered the cost for space missions. However, the size of CubeSats places server limitation on the size of the optical payloads-especially the aperture of the telescope, further exacerbate the sensitivity limitation of CubeSat-based HSIs. New optical systems and methods are needed to overcome the sensitivity limitation due to the very limited aperture size of CubeSat- or small satellite-based instrument.

### SUMMARY

This disclosure is related to a Multi-Slit multipleXed (MSX) HyperSpectral Imaging (HSI) system comprising of a compact high-performance broadband wide-field telescope, and one or a plurality of compact high-performance, demagnifying high-NA spectrographs for high sensitivity hyperspectral imaging. One or more embodiments are directed to the optical components and systems of the MSX HSI systems. In particular, this disclosure relates to designs of compact, broad-band wide-field telescopes to support a plurality of high-performance demagnifying high-NA spectrographs. This disclosure is also related to the design and fabrication of demagnifying high-NA Free-Space Offner-type Spectrographs (FSOS). This disclosure is further related to the design and fabrication of both a free-space design and a high-NA All-immersive Integrated Spectrograph (AMIS) for the MSX HSI systems. Finally, this disclosure describes the methods using an optical system comprising multiple high-NA FSOSs and/or AMISs with a single telescope to achieve high sensitivity and wide swath hyperspectral imaging from space.

One or more embodiments is directed to an Offner spectrometer for use in a multi-slit hyperspectral imaging system for imaging a remote object, including a first surface that is a transmissive surface having a narrow slit receiving light from a multi-spectral light source; a second curved transmissive surface receiving light from the first surface, the second surface having X and Y prescriptions that are decoupled; a third curved reflective surface receiving light from the second surface, the second surface having X and Y prescriptions that are decoupled; a fourth reflective surface that is a curved surface with a grating receiving light from the third surface and diffracting and reflecting light, the fourth surface having X and Y prescriptions that are decoupled; a fifth surface that is curved reflective surface receiving light from the fourth surface, the fourth surface having X and Y prescriptions that are decoupled; a sixth curved transmissive surface receiving light from the fifth surface, the sixth surface having X and Y prescriptions that are decoupled; and a seventh surface that is a focal plane of the Offner spectrometer receiving light from the sixth surface.

The Offner spectrometer may have a demagnification ratio between the first surface and the seventh surface.

At least one of the second, the third, the fourth, the fifth, and the sixth surface may be a curved biconic surface that is aspheric in both an x-axis and a y-axis.

The Offner spectrometer may be a free space spectrometer wherein the first and second surfaces are a same surface, the curvature of which is infinite.

The Offner spectrometer may be a free space spectrometer wherein the sixth and the seventh surface are a same surface and at the focal plane of the spectrograph.

The Offner spectrometer may be an all-immersive space spectrometer wherein the second surface is the entrance surface into a monolithic transparent optical material, and the sixth surface is the exit surface of the monolithic transparent optical material.

The Offner spectrometer may include an eighth surface that is a curved transparent surface between the second and the third surface receiving light from the one slit of the multi-slit and the second surface, wherein the second surface is the entrance surface of a transparent optical material and the eighth surface is the exit surface of the transparent optical material, forming an entrance corrector lens of the Offner spectrometer.

The eighth surface may be a curved biconic surface that is aspheric in both an x-axis and a y-axis.

The Offner spectrometer may include a ninth and a tenth curved transparent surfaces between the eighth and the third surfaces receiving light from the eighth surface, wherein the ninth surface is the entrance surface of a transparent optical material and the tenth surface is the exit surface of the transparent optical material, forming the second element of a doublet entrance corrector lens of the Offner spectrometer.

The Offner spectrometer as claimed in claim 7, further comprising an eleventh curved transparent surface between the fifth and the sixth surface receiving light from the fifth surface, wherein the tenth surface is the entrance surface of a transparent optical material and the sixth surface is the exit surface of the transparent optical material, forming a singlet exit corrector lens of the Offner spectrometer.

The tenth surface is a curved biconic surface that is aspheric in both an x-axis and a y-axis.

One or more embodiments is directed to a multi-slit hyperspectral imaging system for imaging a remote object, including a plurality of slits receiving light from the remote object, a plurality of field distribution systems to receive light output from a corresponding slit, and a plurality of Offner spectrometers to receive light from a corresponding field distribution system. Each Offner spectrometer includes a first surface that is a transmissive surface having a narrow slit receiving light from a multi-spectral light source; a second curved transmissive surface receiving light from the first surface, the second surface having X and Y prescriptions that are decoupled; a third curved reflective surface receiving light from the second surface, the second surface having X and Y prescriptions that are decoupled; a fourth reflective surface that is a curved surface with a grating receiving light from the third surface and diffracting and reflecting light, the fourth surface having X and Y prescriptions that are decoupled; a fifth surface that is curved reflective surface receiving light from the fourth surface, the fourth surface having X and Y prescriptions that are decoupled; a sixth curved transmissive surface receiving light from the fifth surface, the sixth surface having X and Y prescriptions that are decoupled; a seventh surface that is a focal plane of the Offner spectrometer receiving light from the sixth surface; and a plurality of sensors at the seventh? surface of a corresponding Offner spectrometer.

The multi-slit hyperspectral imaging system may include a wide field telescope having a first numerical aperture that directs light from the remote object onto the plurality of slits and each Offner spectrograph is demagnifying and has a second numerical aperture, higher than the first numerical aperture.

The plurality of sensors may be for different spectral windows of a same spatial field sequentially, for a same spectral window and the same spatial field sequentially, or for a same spectral windows and for different spatial fields.

Each field distribution system may include at least one mirror for each slit to distribute the beams from the plurality of slits.

### BRIEF DESCRIPTION OF THE DRAWINGS

The scope of the present disclosure is best understood from the following detailed description of exemplary embodiments when read in conjunction with the accompanying drawings. In the drawing figures, color is used to enhance understanding regarding the optical paths taken therein.

FIG. 1 shows a perspective view of a system including a telescope and two high-NA Free-Space Offner Spectrographs (FSOS) according to an embodiment.

FIG. 2 shows a perspective isometric view (left panel) and side view (right panel) of the telescope of FIG. 1 with a 2-lens corrector and a telecentric lens to enable a wide-field telecentric telescope with F/2.5 focal plane.

FIG. 3 shows the field selection and distribution system of the 2-slit HSI in FIG. 2.

FIG. 4 shows a perspective isometric view (upper left panel), a side view (upper right panel), a top view (lower left panel) and a front view (lower right panel) of a high-NA Free-Space 3 element Offner Spectrograph according to an embodiment.

FIG. 5 shows a side view and a perspective view of system including a simple 2-slit hyperspectral imager that includes a high-NA wide-field telescope, and field selection and distribution system, and two high-NA of a high-NA Free-Space Offner Spectrograph (FSOS) according to an embodiment.

FIG. 6 is a side view and a perspective view of a two high-NA of a high-NA Free-Space Offner Spectrograph (FSOS) of FIG. 5.

FIG. 7 shows the perspective isometric view (upper left panel), a side view (upper right panel), a top view (lower left panel) and a front view (lower right panel) of a high-NA Free-Space Offner Spectrograph according to an embodiment.

FIG. 8 shows a perspective isometric view (upper left panel), a side view (upper right panel), a top view (lower left panel) and a front view (lower right panel) of a high-NA all-reflective, All-immersive Integrated Spectrographs (AMIS) according to an embodiment.

FIG. 9 shows a perspective view (left panel) and a side view (right panel) of the AMIS of FIG. 8.

FIG. 10 shows the field selection and distribution system of a 4-slit HSI using AMIS according to an embodiment.

FIG. 11 shows a field selection and distribution system of a 4-slit HSI using AMIS according to an embodiment.

FIG. 12 shows a system including a telescope and a compact 6-slit hyperspectral imager according to yet another embodiment.

FIGS. 13 and 14 show an embodiment when the slits of two AMISs are offset in both the along-track and perpendicular-to-track directions to create a long-slit to double the swath of the HSI.

### DETAILED DESCRIPTION

This disclosure relates to new optical system designs and methods that enable compact hyperspectral imagers (HSIs) to achieve wide-field high sensitivity hyperspectral imaging from CubeSats. In particular, this disclosure relates to new optical system designs that employs a medium F/# telescope and a plurality of demagnifying high performance spectrographs with fast/high-NA focal planes.

The light gathering capability of the hyperspectral imagers is directly dependent on the aperture of the telescope, and for space-borne instrument a large aperture telescope with a fast (small F/#, or high NA) optical system can reduce the size and weight of the optical system. Subsequently the focal ratios of most existing space-borne hyperspectral imagers are F/2 or smaller.

As is well-known in the field, fast (low F/#), high-NA systems provide high photon flux per unit area at the instrument focus but are difficult to design and fabricate. Therefore, the combination of a medium-F/# telescope (e.g., F/2.5) and a (e.g., 2.5:1) demagnifying fast (F/1) spectrograph has many advantageous characteristics for space-borne hyperspectral imagers. First, the medium F/2.5 focal ratio of the wide field telescope relaxes the optical components fabrication and system alignment tolerances. Secondly, it enables the use of wider entrance slits (2.5× the slit width of a 1:1 magnification spectrograph) for the spectrographs to achieve high spatial resolution while simultaneously reducing slit diffraction. This further effects the use of smaller optical components in the spectrograph without incurring efficiency loss due to slit diffraction. Finally, the large F/# of the telescope facilitates the implementation of a field selection and distribution system that can support a larger number of spectrographs behind a single telescope.

One or more embodiments is directed to demagnifying compact Offner spectrographs that enhances signal-to-noise ratio and/or increases a swath. One or more embodiments is directed a medium-NA (of the order of NA≤0.2, or ≥F/2.5) wide-field telescope and a demagnifying Free-Space Integrated Spectrograph (FSIS) or a demagnifying All-iMmersive Integrated Spectrograph (AMIS) constructed from a monolithic optical material to achieve high NA (of the order of 0.5, or F/1) and high photon collecting power of the instrument system.

One or more embodiments is directed to a compact Offner spectrograph that have curved entrance and exit surfaces. In particular, each surface in the compact Offner Spectrograph may have decoupled X and Y prescriptions, including toroidal, biconic, or biconic Zernike. The curved entrance and exit surfaces provide additional aberration corrections when higher optical performances are needed.

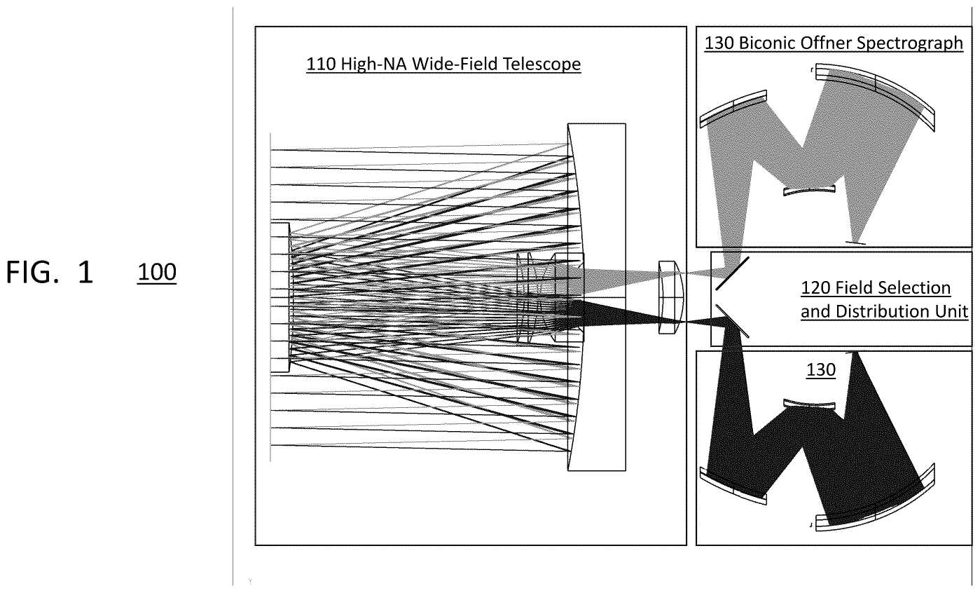

In order to illustrate the operating principle of the MSX HSI, FIG. 1 shows the side view of a 2-slit multiplexed HSI 100 with 2 slits according to an embodiment. MSX-HSI 100 includes a wide-field telecentric telescope 110, a field selection and distribution unit (FSD) 120, and two high-NA demagnifying biconic Offner spectrographs 130, i.e., high-NA Free-Space Offner-type Spectrographs (FSOS), to observe the same slice of the scene in quick secession as the satellite circle earth in orbit. Due to the high orbital speed the difference in time of the two observations ranges from few tens of milliseconds to hundreds of milliseconds depending on the configuration of the FSD 120.

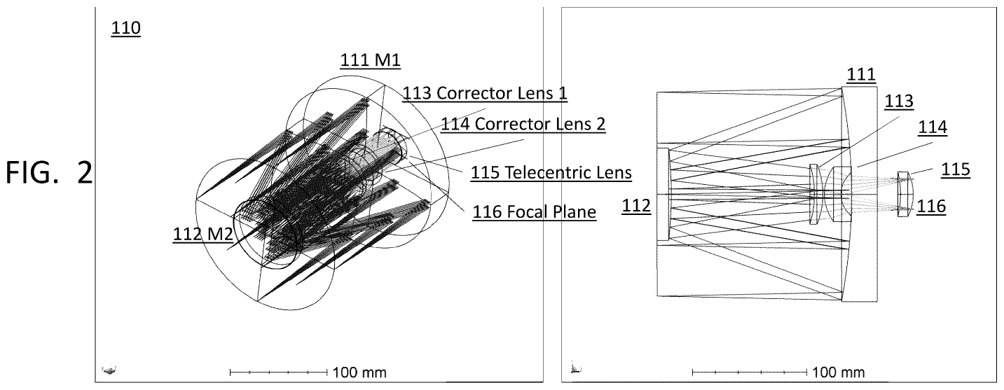

FIG. 2 shows the perspective isometric view and a side view of the wide-field telescope 110 in FIG. 1 with a focal ratio of F/2.5. The telescope employs two aspheric mirrors, namely the primary mirror M1 111, and an aspheric secondary mirror M2 112 arranged in a Richie-Cretien configuration. A two-lens corrector includes corrector lenses 113 and 114 creates a large flat field of view (FOV) with low field curvature. A telecentric lens 115 converts the focusing beams to a telecentric configuration with the pupil of the telescope located at infinity onto a focal plane 116. The F/# of the telescope can be of any value, depending on the requirements of the instrument. The surfaces of the two-lens corrector 113 and 114, and the telecentric lens 115 can be spherical or aspheric, depending on the performance requirements.

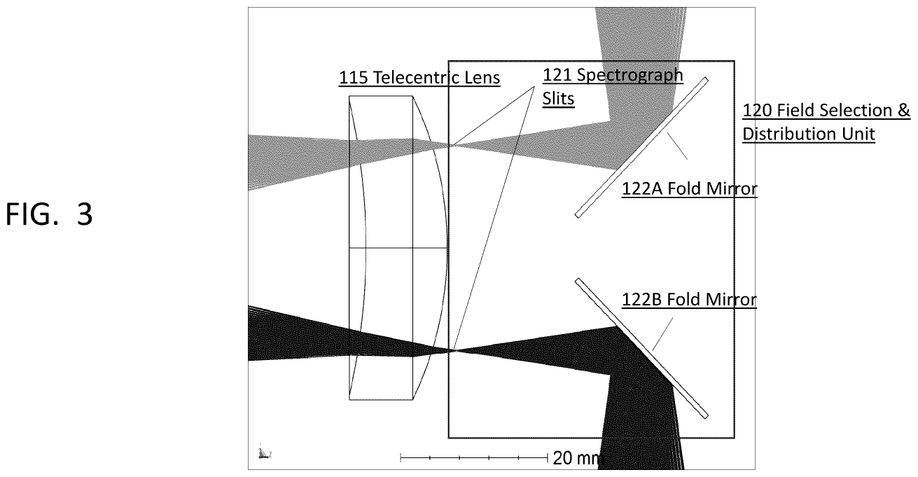

The field selection and distribution unit 120 in FIG. 3 includes two narrow slits 121 oriented perpendicular to the direction of the travel of the satellite, and two small fold mirrors 122. The separation between the two slits 121 were set to allow for ample beam separation behind the slits such that the two fold mirrors do not physically interfere with each other.

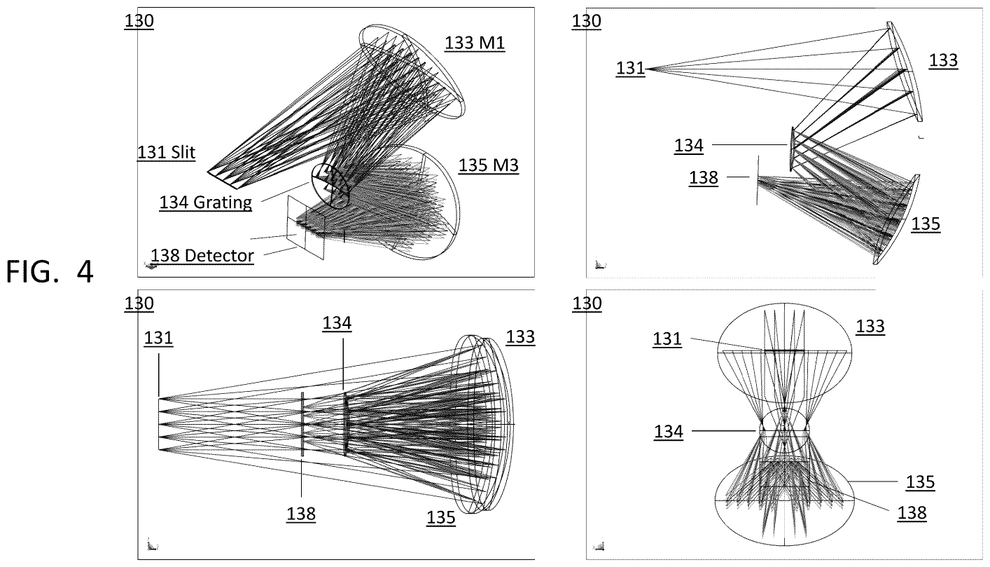

FIG. 4 shows the perspective isometric view, and three side views of the FSOS 130 of the embodiment of FIG. 1 to enable clear illustration of its design. FSIS 130 is a modified 3-element Offner Spectrograph. FSIS 130 has a total of 5 optical surfaces, namely a slit 131, an Offner mirror M1 133, the Offner mirror/diffraction grating M2 134, the Offner mirror M3 135, and a focal plane 138. The optical surfaces M1 133, M2 134, and M3 135 can be spherical, aspherical, biconic, or complex biconic Zernike surfaces with high-order correction, driven by the design requirements. For the most demanding cases biconic or biconic Zernike surfaces usually are needed. Modern high-precision free-form optical fabrication method can accurately place the surfaces with high position and pointing accuracy, eliminating the need for complex optical alignment after fabrication. The slit 131 may be formed on a surface of a transparent optical material having an entrance surface and an exit surface, e.g., in which the entrance surface is coated with an opaque coating with a narrow slit etched on the opaque coating forming an etched glass slit 131 of the spectrograph.

For spectrograph design, the optical prescriptions and performance in the spatial and spectral direction can be decoupled and independently optimized. For example, the final focusing beam of the spectrograph can have different effective focal length such that the linear dispersion of the spectrograph only depends on the effective focal length of the system in the spectral direction, independent and free from the constraint of the effective focal length of the system in the spatial direction, resulting in superior performance. In particular, by using biconic M1 and M3, and potentially the grating 135, prescriptions and performance of the system in the spatial and spectral direction can actually be decoupled and optimized separately. For example, if the imaging system of the spectrograph is an anamorphic system, then the linear dispersion of the spectrograph will not depend on imaging property of the system in the spectral direction. Thus, use of biconic surfaces allows for the independent optimization of the system in the spatial and spectral directions and can achieve much better performance. Although biconic surfaces are disclosed herein, in general any surface that has X and Y prescriptions decoupled, including toroidal, biconic, or biconic Zernike, may realize this advantage.

The FSIS 130 of is similar to conventional all-reflecting Offner spectrographs, but with an aspheric grating 134, and biconic mirrors M1 133 and M3 135. The use of biconic and aspheric surfaces improves the performance of the optical system to allow for the construction of high-performance high-NA spectrographs. Surface 134 can also be a toroidal or biconic when further performance enhancement is required. FSOS 330 further differs from conventional Offner spectrograph in that the M1 133 and M3 135 may have different radius of curvatures to enable magnification or demagnification of the slit image.

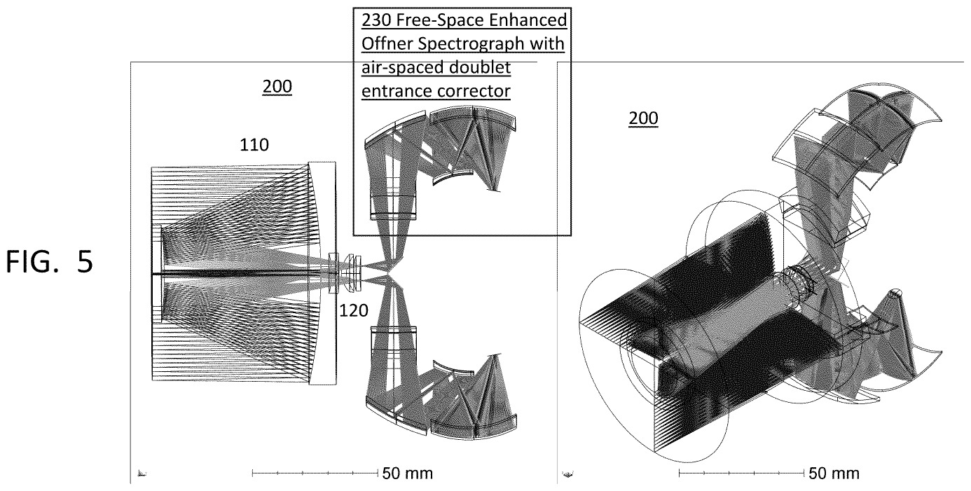

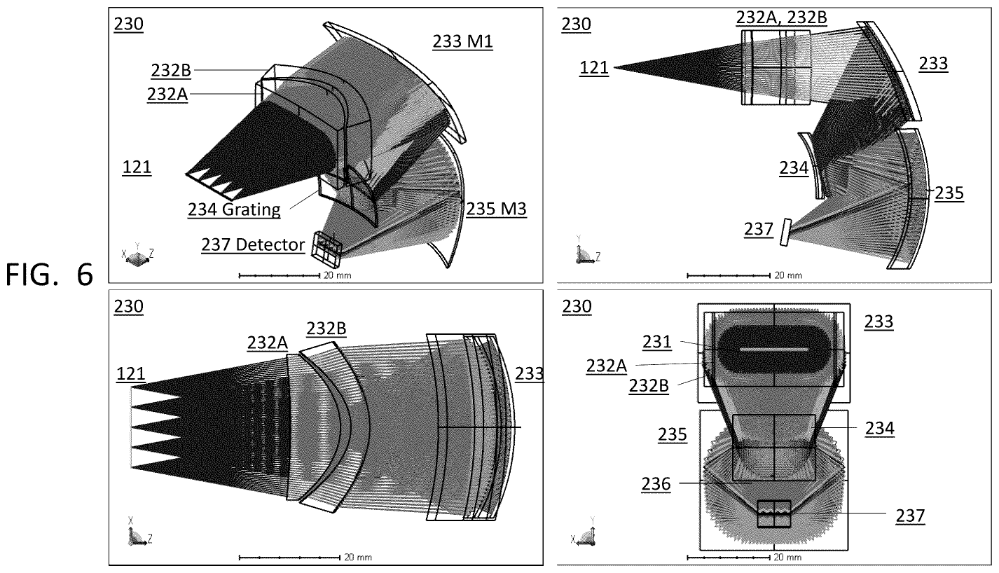

FIGS. 5-6 are directed to a Multi-Slit multipleXed HyperSpectral Imager (MSX-HSI) employing FSOS according to an embodiment. FIG. 5 shows the perspective isometric view and a side view of a 2-slit multiplexed HSI 200 with 2 slits according to an embodiment. MSX-HSI 200 includes the wide-field telecentric telescope 110, the FSD 120, and two high-NA FSOSs 230 to observe the same slice of the scene in quick secession as the satellite circle earth in orbit. Each FSOS 230 also includes an air-spaced doublet entrance collector 232.

As shown in detail in FIG. 6, each FSOS 230 receives light from a corresponding slit 121 which is reduced by the curved two-element entrance corrector 232, thereby reducing the beam width inside the spectrograph. The air-spaced doublet entrance corrector 232 includes a first lens 232A and a second lens 232B and provides a total of four curved surfaces. Herein, the first lens 232A is a plano-convex lens and the second lens 232B is a concavo-convex lens. The beams continue to propagate to a mirror M1 233, a grating/mirror M2 234, a second mirror M3 235, and finally exit to be incident on the detector 237.

The entrance corrector can be a singlet lens, or high performance multi-elements lens, depending on the performance need. Biconic surfaces are used when the system requires high performance.

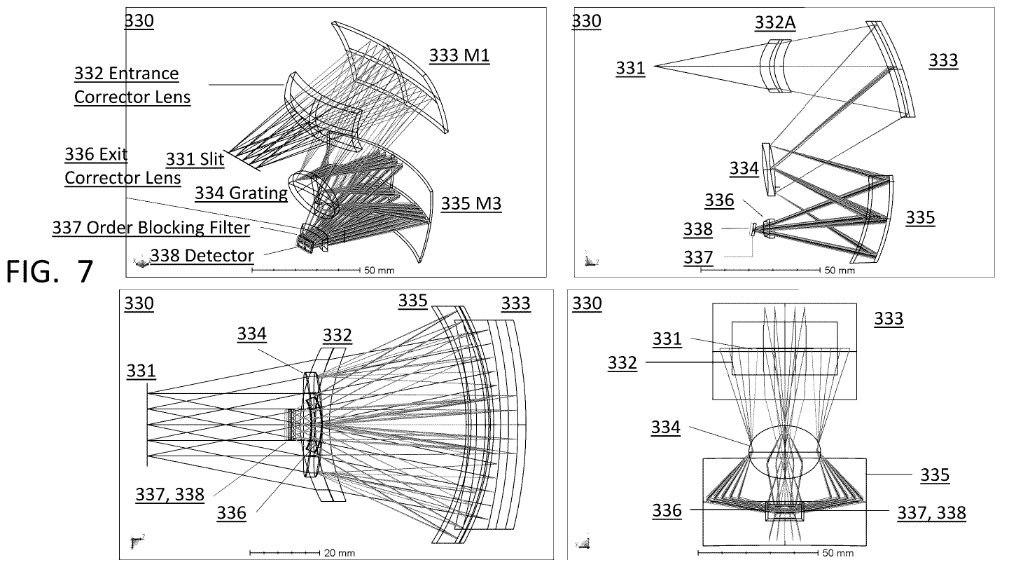

As shown in detail in FIGS. 7, a FSOS 330 according to an embodiment receives light from a corresponding slit 121 which is reduced by the powered entrance corrector 332, thereby reducing the beam width inside the spectrograph. The beams continue to propagate to a mirror M1 333, a grating 334, a second mirror M2 335, and finally exit through a powered exit corrector 336 to be incident on an order blocking filter 337 and the detector 338.

In the embodiments shown in FIG. 1-7, except for the grating, the curved surfaces are all biconic surfaces to push the output of the spectrograph F/# to F/1 or lower while achieving high optical performance. The entrance and exit correctors in these examples are either singlet lens or an air-space doublet. Alternatively, more complicated lens could also be used depending on how far the F/# is to be pushed and the optical performance required. Also, a cemented achromatic doublet may be used. These free-space designs have a demagnification: up to 2:5:1 in these embodiments, making it easier to use in the multi-slit multiplexed hyperspectral imagers. Further, in any of the embodiments disclosed herein, the grating may be a toroidal or biconic grating.

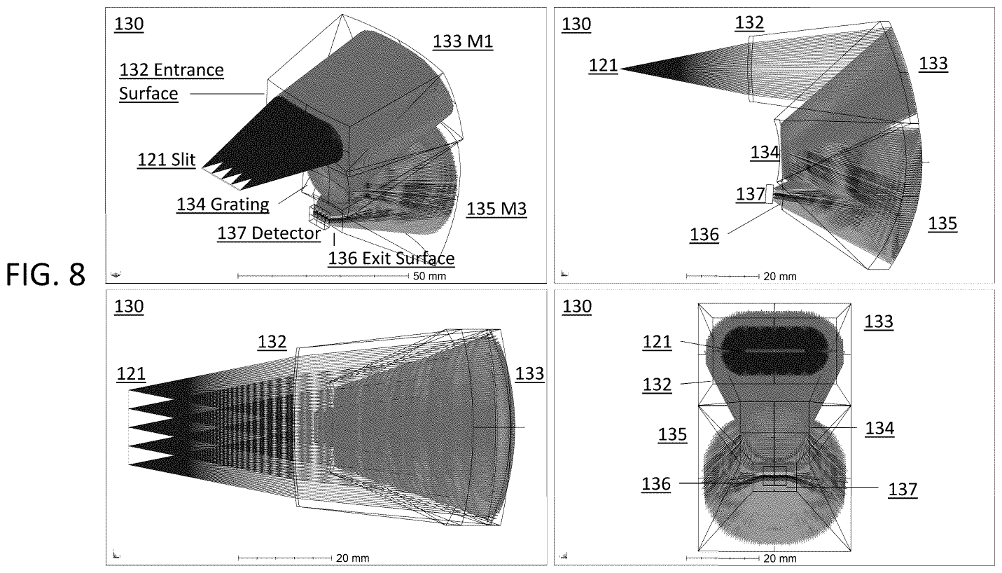

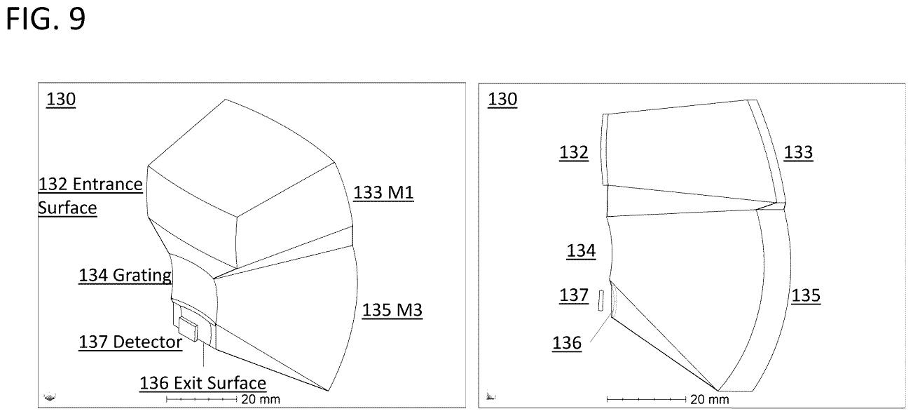

FIG. 8 shows a perspective isometric view, and 3 side views of a high-NA AMIS 430 according to an embodiment. FIG. 9 shows a perspective isometric view and a side view of AMIS 430 to more clearly illustrate the monolithic structure. AMIS 430 is a modified Offner Spectrograph fabricated on a monolithic optical substrate. The substrate material can be broadband optical glass such as fused silica or calcium fluoride (CAF2), or high-index infrared materials such as germanium (Ge), indium phosphite (InPh), or silicon (Si). When appropriate, optical resin and plastic materials can also be used to mass-produce AMIS using molding techniques.

AMIS 430 has a total of 5 optical surfaces, namely an entrance surface 432, an Offner mirror M1 433, an Offner mirror/diffraction grating M2 434, an Offner mirror M3 435, and AMIS exit surface 436. The optical surfaces can be spherical, aspherical, biconic, or complex high-order biconic Zernike surfaces driven by the design requirements. High-precision free-form optical fabrication method can accurately place the surfaces with high position and pointing accuracy, eliminating the need for complex optical alignment after fabrication.

As shown in the top view of AMIS (lower left panel) in FIG. 8, the speed (focal ratio) of the telescope beams passing through the slit 421 are reduced by the curved entrance surface 432, thereby reducing the beam width inside the spectrograph. The beams continue to propagate inside the optical substrate to M2 433, the grating M3, the Offner M3, and finally exit the substrate through the exit surface 436. The Offner spectrograph operating in immersive mode inside the higher index material, allowing the spectrograph to achieve high spectral resolution compared with a free-space Offner spectrograph with the same grating size. The immersive design results in a smaller spectrograph size compared with an Offner spectrograph working in free space. It also results in better image quality of the spectrograph, enabling the instrument to operate with high-NA. An airgap exists between the AMIS exit surface 436 and the sensor 437. However, an alternative, no-air-gap design with a flat AMIS exit surface 436 that is directly in contact with the sensor surface is possible.

AMIS of the embodiments in FIGS. 8 and 9 demagnify the slit length by a factor of 2.5, thereby reducing the focal ratio of the instrument to F/1 with a F/2.5 telescope. The magnification between the entrance slit and focal plane of spectrograph of AMIS can be unity (1), less than 1 (demagnifying), or greater than 1.

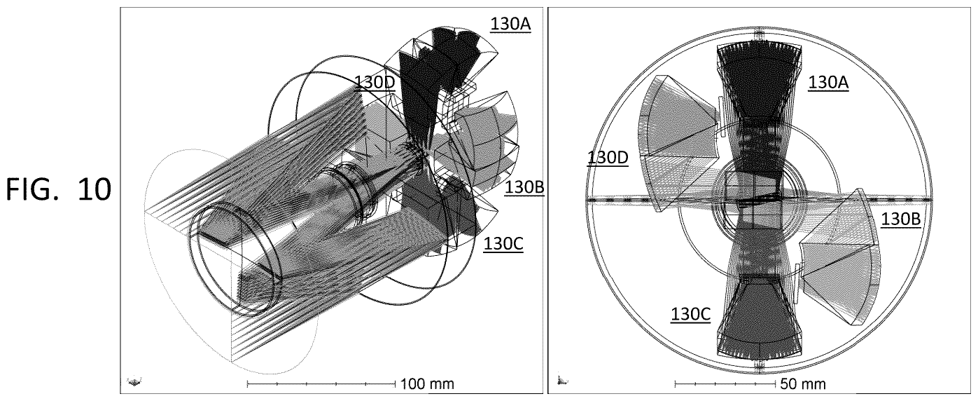

FIG. 10 shows a MSX HSI with a 4-slit field selection and distribution unit followed by four AMIS 430. The small size of the AMISs enable the deployment of more spectrographs behind a single telescope.

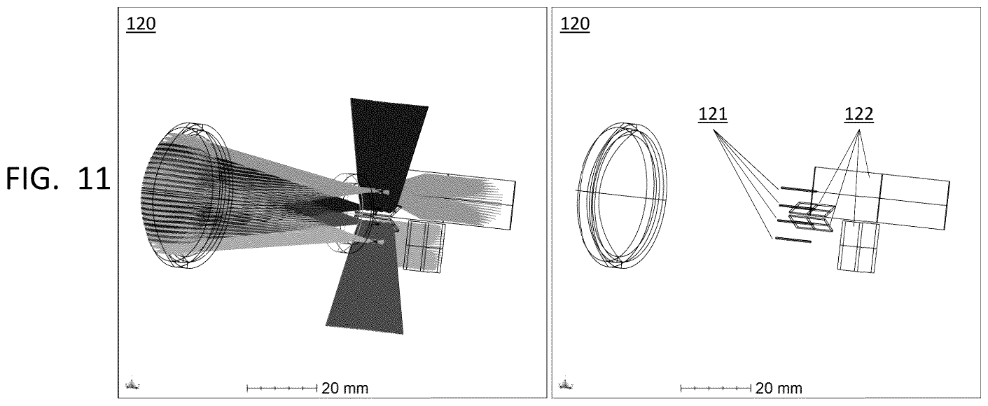

FIG. 11 shows the field selection and distribution unit of a 4-slit MSX HSI that includes four AMIS 430A to 430D. The left panel shows a FSD unit 420 with ray traces showing how the beams are directed. The right panel shows the FSD unit 420 without ray traces to show the arrangement of the four fold mirrors clearly.

FIG. 11 shows the field selection and distribution unit 420 for use with two of the fold mirrors 121 direct the beam in the +Y and −Y direction as that of the FSD unit of FIG. 2. Two additional fold mirrors 422 direct the beams from two additional slits in the +X and −X direction.

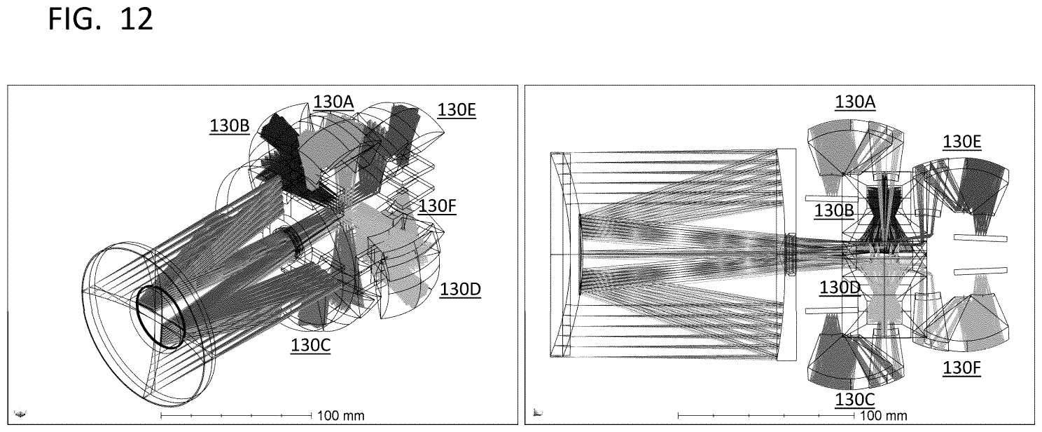

Depending on the requirements of the mission, the total number of slits and AMISs in an MSX HSI can be adjusted. FIG. 12 shows an embodiment with six AMIS in a single system. The telescope is a catadioptric Schmidt-Cassegrain design with an additional corrector.

Similar to the free-space design, the all-immersive design has a demagnification: up to 2:5:1 in these embodiments, making it easier to use in a multi-slit spectrograph. Further, in any of the embodiments disclosed herein, the grating may be a toroidal or a biconic grating.

The compactness of the above spectrographs allows for flexible configuration of the spectrographs to optimize the instrument for the science missions. For example, the slits of MSX HSIs can be arranged with an offset only in the direction along the satellite track as depicted in FIG. 2, thereby enabling repeated measurements of the scene with a short delay between measurements. The delays between successive measurements are typically much less than 1 second for satellites in low earth orbits (LEOs), therefore these measurements can be considered ‘simultaneous’ and be combined to improve the signal-to-noise ratio of the measurements.

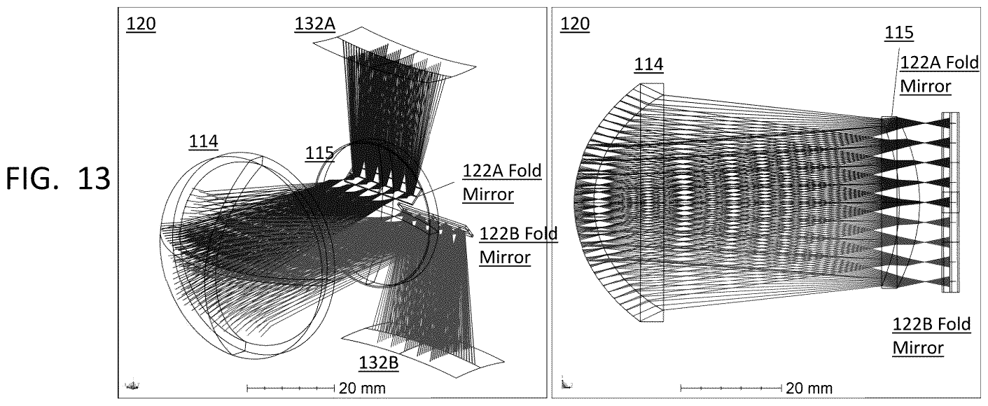

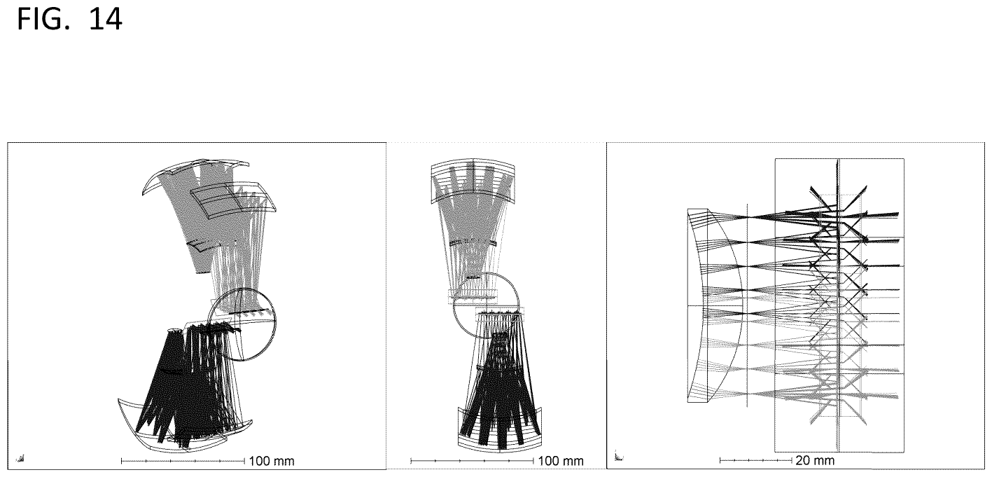

The slits of the FSD can also be configured to extend the swath of the MSX-HSI by offsetting the positions of the slits in the direction along and perpendicular to the track of the satellites, such as shown in FIGS. 13 and 14.

Alternatively, depending on the mission needs, any of the spectrographs can be configured to sample different, and narrower spectra window with higher spectral resolution, and be equipped with different sensors optimized for each spectral window to optimize the observations for specialized mission. For example, the plurality of sensors may be for different spectral windows of a same spatial field sequentially to increase spectral window coverage.

For MSX HSIs equipped with a large number of spectrographs, a subset of the plurality of the spectrograph can be configured to sample a same spectral window and the same spatial field sequentially to improve the SNR of measurements, while another subset of spectrographs can be configured to sample the same spectral window and different spatial fields to also increase the swath of the measurement.

Alternatively, for MSX HSIs equipped with a large number of spectrographs, a subset of the plurality of the spectrograph can be configured to sample different spectral window and the same spatial field sequentially for extended spectral window coverage, while another subset of spectrographs can be configured to sample the same spectral window but a different spatial fields to also increase the swath of the measurement. This configuration is particularly advantageous when the total number of spectral channels required to fulfil the scientific mission exceeds the number of spectral channels that can be supported by the sensors.

Furthermore, for MSX HSIs equipped with a large number of spectrographs, a subset of the plurality of the spectrograph can be configured to sample different spectral window and the same spatial field sequentially for extended spectral window coverage, while a second subset of the plurality of the spectrograph can be configured to cover the same extended spectral window and of the same spatial field as the first subset of the spectrograph sequentially, to increase both the spectral window coverage and SNR of the measurement of the field.

It should be clear to those familiar with the art, the ability to support a large number of spectrographs behind a telescope allows the designers to increase the SNR, the spectral window coverage, and the swath of the instrument in different combinations, or all simultaneously.

The present disclosure is not limited to only the above-described embodiments, which are merely exemplary. It will be appreciated by those skilled in the art that the disclosed systems and/or methods can be embodied in other specific forms without departing from the spirit of the disclosure or essential characteristics thereof. The presently disclosed embodiments are therefore considered to be illustrative and not restrictive. The disclosure is not exhaustive and should not be interpreted as limiting the claimed invention to the specific disclosed embodiments. In view of the present disclosure, one of skill in the art will understand that modifications and variations are possible in light of the above teachings or may be acquired from practicing of the disclosure.

1. An Offner spectrometer for use in a multi-slit hyperspectral imaging system for imaging a remote object, the Offner spectrometer comprising:
a first surface that is a transmissive surface having a narrow slit receiving light from a multi-spectral light source;
a second curved transmissive surface receiving light from the first surface, the second surface having X and Y prescriptions that are decoupled;
a third curved reflective surface receiving light from the second surface, the second surface having X and Y prescriptions that are decoupled;
a fourth reflective surface that is a curved surface with a grating receiving light from the third surface and diffracting and reflecting light, the fourth surface having X and Y prescriptions that are decoupled;
a fifth surface that is curved reflective surface receiving light from the fourth surface, the fourth surface having X and Y prescriptions that are decoupled;
a sixth curved transmissive surface receiving light from the fifth surface, the sixth surface having X and Y prescriptions that are decoupled; and
a seventh surface that is a focal plane of the Offner spectrometer receiving light from the sixth surface.

2. The Offner spectrometer as claimed in claim 1, wherein the Offner spectrometer has a demagnification ratio between the first surface and the seventh surface.

3. The Offner spectrometer as claimed in claim 1, wherein at least one of the second, the third, the fourth, the fifth, and the sixth surface is a curved biconic surface that is aspheric in both an x-axis and a y-axis.

4. The Offner spectrometer as claimed in claim 1, wherein the Offner spectrometer is a free space spectrometer wherein the first and second surfaces are a same surface, the curvature of which is infinite.

5. The Offner spectrometer as claimed in claim 1, wherein the Offner spectrometer is a free space spectrometer wherein the sixth and the seventh surface are a same surface and at the focal plane of the spectrograph.

6. The Offner spectrometer as claimed in claim 1, wherein the Offner spectrometer is an all-immersive spectrometer wherein the second surface is the entrance surface into a monolithic transparent optical material, and the sixth surface is the exit surface of the monolithic transparent optical material.

7. The Offner spectrometer as claimed in claim 1, further comprising an eighth surface that is a curved transparent surface between the second and the third surface receiving light from the one slit of the multi-slit and the second surface, wherein the second surface is the entrance surface of a transparent optical material and the eighth surface is the exit surface of the transparent optical material, forming an entrance corrector lens of the Offner spectrometer.

8. The Offner spectrometer as claimed in claim 7, wherein the eighth surface is a curved biconic surface that is aspheric in both an x-axis and a y-axis.

9. The Offner spectrometer as claimed in claim 8, further comprising a ninth and a tenth curved transparent surfaces between the eighth and the third surfaces receiving light from the eighth surface, wherein the ninth surface is the entrance surface of a transparent optical material and the tenth surface is the exit surface of the transparent optical material, forming a second element of a doublet entrance corrector lens of the Offner spectrometer.

10. The Offner spectrometer as claimed in claim 9, wherein the ninth and the tenth surface are curved biconic surface that is aspheric in both an x-axis and a y-axis.

11. The Offner spectrometer as claimed in claim 9, further comprising an eleventh curved transparent surface between the fifth and the sixth surface receiving light from the fifth surface, wherein the tenth surface is the entrance surface of a transparent optical material and the sixth surface is the exit surface of the transparent optical material, forming a singlet exit corrector lens of the Offner spectrometer.

12. The Offner spectrometer as claimed in claim 11, wherein the eleventh surface is a curved biconic surface that is aspheric in both an x-axis and a y-axis.

13. A multi-slit hyperspectral imaging system for imaging a remote object, comprising:
a plurality of slits receiving light from the remote object;
a plurality of field distribution systems to receive light output from a corresponding slit;
a plurality of Offner spectrometers to receive light from a corresponding field distribution system, each Offner spectrometer including
a first surface that is a transmissive surface having a narrow slit receiving light from a multi-spectral light source;
a second curved transmissive surface receiving light from the first surface, the second surface having X and Y prescriptions that are decoupled;
a third curved reflective surface receiving light from the second surface, the second surface having X and Y prescriptions that are decoupled;
a fourth reflective surface that is a curved surface with a grating receiving light from the third surface and diffracting and reflecting light, the fourth surface having X and Y prescriptions that are decoupled;
a fifth surface that is curved reflective surface receiving light from the fourth surface, the fourth surface having X and Y prescriptions that are decoupled;
a sixth curved transmissive surface receiving light from the fifth surface, the sixth surface having X and Y prescriptions that are decoupled; and
a seventh surface that is a focal plane of the Offner spectrometer receiving light from the sixth surface; and
a plurality of sensors at the seventh surface of a corresponding Offner spectrometer.

14. The multi-slit hyperspectral imaging system as claimed in claim 13, further comprising a wide field telescope having a first numerical aperture that directs light from the remote object onto the plurality of slits and each Offner spectrograph is demagnifying and has a second numerical aperture, higher than the first numerical aperture.

15. The multi-slit hyperspectral imaging system as claimed in claim 13, wherein the plurality of spectrographs and their corresponding sensors are for different spectral windows of a same spatial field sequentially.

16. The multi-slit hyperspectral imaging system as claimed in claim 13, wherein the plurality of spectrographs and their corresponding sensors are for a same spectral window and a same spatial field sequentially.

17. The multi-slit hyperspectral imaging system as claimed in claim 13, wherein the plurality of spectrographs and their corresponding sensors are for a same spectral windows and for different spatial fields.

18. The multi-slit hyperspectral imaging system as claimed in claim 13, wherein each field distribution system includes at least one mirror for each slit to distribute beams from the plurality of slits.
